(19) United States
(12) Patent Application Publication
(10) Pub. No.: US 2014/0366991 A1
(43) Pub. Date: Dec. 18, 2014

(54) METHOD FOR REDUCING A RARE EARTH-BASED MAGNET

(71) Applicant: VACUUMSCHMELZE GMBH & CO.KG, Hanau (DE)

(72) Inventors: Christoph BROMBACHER, Wiesbaden (DE); Katja VOELKER, Kahl (DE); Joerg DREIKORN, Langenselbold (DE)

(21) Appl. No.: 14/303,318

(22) Filed: Jun. 12, 2014

Related U.S. Application Data
(60) Provisional application No. 61/834,099, filed on Jun. 12, 2013.

(51) Int. Cl. H01F 41/02; C21D 9/00

(52) U.S. Cl. CPC H01F 41/0293; C21D 9/0068
USPC 148/121; 427/58

(57) ABSTRACT

A method of treating a rare earth-based magnet is provided that comprises the following. At least one precursor sintered R₂Fe₁₄B-type magnet having a body is provided. A paste is provided that comprising particles comprising a rare earth element R′ and applied to at least one surface other than a surface of the body and a layer of the particles is formed on the at least one surface providing a source of the rare earth element R′. The precursor sintered R₂Fe₁₄B-type magnet is placed adjacent the layer and the rare earth element R′ diffused into the precursor sintered R₂Fe₁₄B-type magnet from the source, whilst the precursor sintered R₂Fe₁₄B-type magnet is adjacent the layer and increasing the content of the R′ rare earth element at least at the outer surface of the body. A rare earth-based magnet is produced.

This application claims benefit of U.S. Provisional Application Ser. No. 61/834,099, filed 12 Jun. 2013, the entire content of which is incorporated herein by reference for all purposes.

### BACKGROUND

1. Field

Rare earth-based magnets, such as sintered Nd₂Fe₁₄B-type magnets, are used in many applications, for example as a compovent of a motor of a hybrid car.

2. Description of Related Art

It is desirable to increase the coercivity without decreasing the remanence of these rare earth-based magnets so that the magnet has a high maximum energy product.

US 2009/0252865 discloses a grain boundary diffusion method for Nd₂Fe₁₄B-type magnets in which the dysprosium and/or terbium is applied in the form of a metal powder to a paraffin coated sintered Nd₂Fe₁₄B-type magnet. A heat treatment is carried out under conditions suitable to cause the dysprosium and/or terbium to diffuse along the grain boundaries resulting in an increased coercivity of the magnet.

This grain boundary diffusion process has the advantage that the coercivity of the Nd₂Fe₁₄B-type magnet is increased and, at the same time, the residual flux density is maintained so that it is comparable to that of a sintered Nd₂Fe₁₄B-type magnet that has not undergone the grain boundary diffusion treatment.

This method of applying dysprosium and/or terbium powders to the outside of a sintered Nd₂Fe₁₄B-type magnet has the advantage over the use of vacuum deposition techniques, such as sputtering, to deposit the dysprosium and/or terbium that it is cheaper to perform and the material loss is lower. As dysprosium and, especially, terbium are expensive, effective use of these elements is desirable.

However, further methods for producing rare earth-based magnets with a high maximum energy product which can be performed more cost effectively are desirable.

### SUMMARY

A method of treating a rare earth-based magnet is provided that comprises the following. At least one precursor sintered R₂Fe₁₄B-type magnet having a body is provided. A paste is provided that comprises particles comprising a rare earth element R′ and applied to at least one surface other than a surface of the body to form a layer of the particles on the at least one surface providing a source of the rare earth element R′. The precursor sintered R₂Fe₁₄B-type magnet is placed adjacent the layer and the rare earth element R′ is diffused into the precursor sintered R₂Fe₁₄B-type magnet from the source, whilst the precursor sintered R₂Fe₁₄B-type magnet is adjacent the layer and increasing the content of the R′ rare earth element at least at the outer surface of the body to produce a rare earth-based magnet.

The rare earth element R′, which is introduced into the precursor sintered magnet by diffusion, is not applied to the outer surface of the body of the precursor sintered R₂Fe₁₄B-type magnet, but applied to a different surface, such as a surface of a support, or a container, or packaging and the surface including a layer of particles comprising the rare earth element R′ is positioned adjacent the precursor sintered R₂Fe₁₄B-type magnet during the diffusing. The layer of particles comprising the rare earth element R′ provides a source of the rare earth element R′ which is used to increase the content of the element R′ of the rare earth magnet during the diffusing.

This method may be used to avoid residues of the paste remaining on the outer surface of the magnet after the diffusing, since the paste is not applied directly onto the outer surface of the precursor sintered magnet. A single layer of particles comprising a rare earth element R′ can be applied to the surface and two or more precursor sintered magnets placed in contact with the single layer on the surface. This method avoids the need to apply paste to the two or more precursor sintered magnets and can aid in simplifying application of the particles of the rare earth element R′.

The paste is applied exclusively to one or more surfaces other than surfaces of the body of the at least one precursor sintered R₂Fe₁₄B-type magnet. Paste is not applied to the at least one precursor sintered magnet at any time in the method. In embodiments, in which two or more precursor sintered R₂Fe₁₄B-type magnets are treated, the paste is not applied to any of the surfaces of the two or more precursor sintered R₂Fe₁₄B-type magnets and is applied only on at least one different surface, such as a surface of a support and/or inner surface of a container or other packaging.

The precursor sintered R₂Fe₁₄B-type magnet may be placed in direct contact with the layer and the rare earth element R′ is diffused into the precursor sintered R₂Fe₁₄B-type magnet whilst the precursor sintered R₂Fe₁₄B-type magnet is in direct contact with the layer. The precursor sintered R₂Fe₁₄B-type magnet may be spaced at a distance from the layer and the rare earth element R′ is diffused into the precursor sintered R₂Fe₁₄B-type magnet, whilst the precursor sintered R₂Fe₁₄B-type magnet is spaced at a distance from the layer.

The rare earth element R′ is able to diffuse not only into a surface of the precursor sintered magnet which is in direct contact with the layer comprising the particles of rare earth element R′, but also by gaseous diffusion into further surfaces of the precursor sintered magnet which are not in direct contact with the layer. Therefore, the method is suitable for treating irregular shaped magnets.

The method may also be useful for producing a rare earth-based magnet having an outer form onto which it is inconvenient to apply the paste by some methods. For example, screen printing may be an inconvenient method for applying a layer to a precursor sintered magnet having an irregular outer form or a precursor sintered magnet having nonparallel opposing sides such as pyramid or a prism.

A rare earth element is defined as one of the group of elements consisting of the lanthanide elements of the periodic table and, additionally, scandium and yttrium.

A R₂Fe₁₄B-type is used to describe the structure of the phase rather than the composition. For example, R may represent two or more rare earth elements included as a mixture in the R₂Fe₁₄B structure. A R₂Fe₁₄B-type magnet may also include further elements such as metallic elements, for example Al, Co, Cu and Ga and additional phases such as rare earth rich phases.

The rare earth element R′ is defined as one or more of these elements which has the ability to diffuse along grain boundaries of a sintered R₂Fe₁₄B-type magnet. R′ may be Dysprosium and/or Terbium. The rare earth element R′ is further defined herein as the rare earth element which is applied to the surface adjacent the precursor sintered magnet. In some embodiments, the precursor sintered magnet also comprises the same rare earth element R′ which is applied to the surface. However, the content of the rare earth element R′ of the sintered magnet is increased after the diffusing.

In an embodiment, the method further comprises applying particles of a separation material between the at least one surface including the layer of particles comprising the rare earth element R′ and the precursor magnet. The particles of the separation material may be applied to the surface or to the precursor magnet. The separation material is selected to remain solid and particulate after the diffusing and so acts as a separating material. The separation material may be useful to prevent adhesion of the magnets to residues of the layer and/or the surface of the support on which the magnet is placed during the diffusing and to allow the treated rare earth-based magnets to be easily removed from the support. For example, the separation material may be neodymium oxide or alumina or silica.

The particles of the rare earth element R′ and particles of the separation material may be intimately mixed with one another and, afterwards, applied as a mixture to the at least one surface in the form of a single layer. The particles of rare earth element R′ and the particles of the separation material may be mixed with at least one liquid or organic substance to form a paste which is applied to the at least one surface.

In some embodiments, one or more binders and/or one or more dispersants may be added to the paste. The binders and dispersants may be used to prevent agglomeration and/or sedimentation of the particles of the rare earth element R′ and the particles of the separation material, if present, so that a homogenous and uniform layer can be applied to the surface.

The paste may be applied to the surface by any suitable method for example by painting, screen printing, doctor blading, gravity, dipping, roller application or spraying.

The amount of the binder, dispersant and liquid organic substance may be adjusted to adjust the viscosity of the paste and the particle content of the paste. The viscosity and/or particle content may be adjusted to make the paste more convenient to apply by a particular method or to produce a layer with a desired thickness and, therefore, a desired amount of the rare earth element R′.

The diffusing of the rare earth element R′ into the precursor sintered magnet whilst the precursor sintered magnet is adjacent with the layer may be carried out by heat treating the precursor sintered magnet and the surface at a temperature T₁ for a time t₁. The temperature T₁ and the time t₁ may be selected depending on the rare earth element R′ which is selected and on the length of the diffusion path into the precursor sintered magnet. For example, the time may be increased for a larger magnet since the element R′ has a longer diffusion path from the outer surface to the centre of the magnet.

The surface on which the paste is applied may be a surface of a support or a container. In this embodiment, the diffusing may be carried out by heat treating the precursor sintered R₂Fe₁₄B-type magnet and the support or the container at a temperature T₁ and for a time t₁.

The temperature T₁ may lie within the range of 600° C. to 1100° C. and the time t₁ may lie within the range of 0.1 hours to 100 hours.

The heat treating may be carried out under a pressure of less than 0.05 mbar. Reducing the pressure and carrying out the heat treatment under the reduced pressure may be used to aid the diffusion of the rare earth element R′ into the precursor sintered magnet. For example, the reduced pressure may aid the diffusion of the rare earth element R′ in the gaseous phase.

After the diffusing, the rare earth-based magnet may be subjected to further annealing treatment in Argon at a temperature T₂ for a time t₂. The temperature T₂ may be less than the temperature T₁ at which the diffusing treatment is performed.

The additional annealing treatment may be used to increase the coercivity of the magnet. The temperature T₂ may lie within the range of 350° C. to 850° C. and time t₂ may lie within the range of 0.1 hours to 10 hours.

After the layer is applied to at least one surface of the support, the layer may be dried before being heat treated at the temperature T. Drying of the layer may be used to assist in the removal of the magnets from the layer after heat treatment of the temperature T. The layer may be dried by placing the support into a vacuum.

The surface, onto which the layer comprising the particles of the rare earth element R′ is placed, may form part of a container or a support or may be part of a further object that is placed into a container and the precursor sintered magnet is positioned in direct contact with or adjacent the layer within the container during the diffusing. The container may enclose the precursor sintered magnet on all sides such that the precursor sintered magnet is sealed within the container. Alternatively, the container may have at least one opening which enables the inside of the container to be evacuated along with the region outside of the container, for example the inside of the furnace. A container may be used if the rare earth element R′ is to diffuse to the precursor sintered magnet by the gaseous phase in order to retain the rare earth element R′ in the gaseous phase in the vicinity of the precursor sintered magnet and increase the partial pressure of the rare earth element R′ around the precursor sintered magnet.

The paste may also be applied to at least one second surface to form a second layer including particles of the rare earth element R′ and, optionally, particles of the separation material. The second layer is also present in the container during the diffusing. The at least one second surface may be part of the inner wall of the container or may be an additional structure placed into the container along with the support and the precursor sintered magnet. The second layer may be in direct contact with, or may be spaced at a distance from, the precursor sintered magnet during the diffusing. If the rare earth element R′ on the at least one second surface is not in direct contact with the precursor sintered magnet during the diffusing, the rare earth element R′ present in the second layer reaches the precursor sintered magnet by a gaseous diffusion mechanism.

The at least one second surface with a second layer including particles of the rare earth element R′ and, optionally, particles of the separation material may be positioned opposite to the layer so that the precursor sintered magnet is positioned between the second layer and the first layer comprising particles of the rare earth element R′. This arrangement may be used to provide a more homogenous distribution of the rare earth element R′ around the precursor sintered magnet.

The container and support may comprise a material which shows little, if any, reaction with the rare earth element R′ during the diffusing. This avoids unnecessary wastage of the rare earth element R′ due to the formation of reaction products with the support or container. Suitable materials for the support and container are molybdenum metal and titanium metal, for example.

The layer comprising the rare earth element R′ and, optionally, the separation material has an area and thickness. The thickness of the layer may vary across the area so that the layer has thinner regions and thicker regions. The thicker regions may be produced by selectively applying a second sub-layer to a first sub-layer, for example.

In one embodiment, the precursor sintered magnet is placed in direct contact with a thinner region of the layer. A thicker region of the layer may be arranged adjacent to the precursor sintered magnet. The thicker region may be provided adjacent the precursor sintered magnet in order to provide a larger source of particles of the rare earth element R′ for gaseous diffusion to the outer surfaces of the precursor sintered magnet which are not in direct contact with the layer.

At least one of the area and the thickness of the layer may be selected to provide a predetermined amount of the rare earth element R′. In other words, at least one of the area and the thickness of the layer is configured such that a predetermined amount of the rare earth element R′ is provided. In embodiments in which paste comprising particles of rare earth element R′ is applied to two or more surfaces, the layer is considered to be the total of the paste applied to two or more surfaces, i.e. the layer is distributed over the two or more surfaces.

The area and/or the thickness may be selected to provide a predetermined amount of rare earth element R′ depending on the amount of the R₂Fe₁₄B-type phase placed on the layer or within the container. In other words, at least one of the area and the thickness of the layer is configured such that a predetermined amount of the rare earth element R′ is provided depending on the amount of the R₂Fe₁₄B-type phase placed on the layer. For example, for large magnets having a large amount of the R₂Fe₁₄B-type phase, the amount of rare earth element R′ can be increased. For example, if the mass of the R₂Fe₁₄B-type phase in a single diffusing treatment is m, 0.3 wt % x m to 0.6 wt % x m of the rare earth element R′ may be provided in the layer.

The thickness of the layer may be adjusted by applying a first sub layer having a first thickness and applying a second sub layer having a second thickness on portions of the first sub-layer.

The thickness of the layer may also be adjusted applying a first portion of the layer to a first surface and a second portion of the layer to a second surface, the first portion and the second portions having differing thicknesses.

The differing thicknesses of the layer or layers and their relative position to the precursor sintered magnets may be adjusted so as to provide a homogeneous distribution of the R′ element across the surface of the magnet after the diffusing.

In an embodiment, at least one of the area and the thickness of the layer is selected to provide a predetermined amount of the rare earth element R′ in a predetermined portion of the magnet positioned adjacent the layer. In other words, at least one of the area and the thickness of the layer configured such that a predetermined amount of the rare earth element R′ is provided in a predetermined portion of the magnet positioned adjacent the layer. This embodiment may be used to increase the content of the R′ element in predetermined regions of the magnet compared to the R′ content in other regions of the magnet. This may be useful if certain portion or regions of the magnet are subjected to differing demagnetizing fields when operating in an application for example.

The particles of the rare earth element R′ of the paste used to form the layer and the particles of rare earth element R′ within the layer may be provided as a metal or alternatively in the form of a hydride, a fluoride, a bromide, an iodide or an alloy or a hydrogenated alloy.

In some embodiments, 0.01 wt % to 2 wt % or 0.1 wt % to 0.6 wt % of the rare earth element R′ in relation to the weight of the magnet is applied to the surface.

The volume ratio of rare earth element R′ to the separation material, if present, is between 100 to 1 and 1 to 10.

The separation material may be an oxide such as neodymium oxide or an oxide of the majority rare earth element of the magnet. However, separation material may be an oxide of a rare earth element R″, where R″ is different from R and from R′. The separation material may also comprise particles of aluminium oxide or silicon dioxide.

In a particular embodiment, the paste comprises DyₓH_{z}, Nd₂O₃, fumed silica and 3-methoxy-1-butanol.

### BRIEF DESCRIPTION OF DRAWINGS

Particular embodiments and examples will now be described with reference to the accompanying drawings and table.

FIG. 1 illustrates an arrangement for producing a rare earth-based magnet according to a first embodiment.

FIG. 2 illustrates an arrangement for producing a rare earth-based magnet according to a second embodiment.

FIGS. 3A and 3B illustrate the production of rare earth-based magnets.

FIG. 4 illustrates a graph of coercivity and increase in coercivity for samples given a diffusion treatment.

FIG. 5 illustrates a graph of coercivity and remanence for samples given a diffusion treatment for varying distances between the source and sample.

FIG. 6 illustrates a graph of coercivity and remanence for samples heat treated in containers of differing materials.

FIG. 7 illustrates a graph indicating an increase in coercivity after a diffusion treatment for a sample having a prismatic form with a triangular cross-section.

FIG. 8 illustrates graph indicating an increase in coercivity after a diffusion treatment for a sample having a cuboid form.

Table 1 illustrates the dimensions and mass of samples before and after a diffusion treatment.

### DETAILED DESCRIPTION OF SPECIFIC EMBODIMENTS

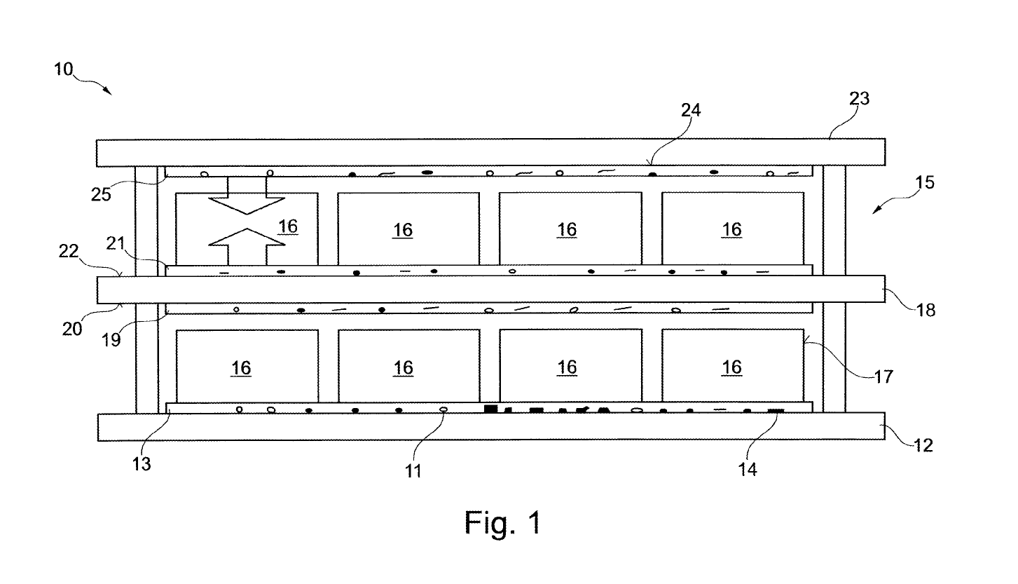

FIG. 1 illustrates an arrangement 10 for producing a rare earth-based magnet, in particular, for treating a rare earth-based magnet such as a sintered R₂Fe₁₄B-type magnet, using a grain boundary diffusion process.

In order to increase the coercivity of a precursor sintered R₂Fe₁₄B-type magnet, the precursor sintered magnet is heat treated along with a source of dysprosium in order to allow the dysprosium to diffuse into the precursor sintered magnet along the grain boundaries. The dysprosium source is provided in the form of particles 11 of dysprosium hydride which are formed into a paste and applied to a support 12 to form a first layer 13 including dysprosium hydride particles. The arrangement may also be used for other source materials, such as terbium or terbium compounds, which also lead to an increase in coercivity of R₂Fe₁₄B-type magnets. The dysprosium particles may also be provided as dysprosium metal or a dysprosium alloy. The paste and first layer 13 including the dysprosium containing particles may further include particles 14 of a separation material.

The support 12 forms part of a closed container 15 into which a plurality of precursor sintered R₂Fe₁₄B-type magnets 16 are placed. The precursor sintered magnets 16 have an outer surface 17 which is free of an additional layer including a rare earth element R′, R′ being a rare earth element such as Dy and/or Tb which can diffuse into the R₂Fe₁₄B phase and cause an increase in coercivity. The outer surface may have an average composition equal to the average composition of the precursor sintered magnet.

The particles of dysprosium hydride are not applied directly onto the outer surface 17 of the precursor sintered magnets 16, but are applied to the support 12. In this particular embodiment, the uncoated precursor sintered magnets 16 are placed in direct contact with the first layer 13 including the dysprosium hydride particles 11 positioned on the support 12. In some embodiments, the uncoated precursor sintered magnets 16 are placed adjacent to, and spaced at a distance from, the first layer 13 including the dysprosium hydride particles 11. In this particular embodiment, the support 12 and container 15 are molybdenum metal. In other embodiments, the support and container may be other metals, for example titanium.

In the arrangement illustrated in FIG. 1, the container 15 has two stacked support structures so that two layers of precursor magnets 16 can be heat treated at the same time. The second support 18 is positioned above a first layer of precursor sintered magnets 16 so the precursor sintered magnets 16 are sandwiched between the first support 12 and the second support 18. The second support 18 has a second layer 19 formed by the paste on its underside 20 and a third layer 21 formed from the paste on its upper side 22. The second layer 19 on the underside 20 of the second support 18 faces towards the upper surface of the precursor sintered magnets 16 of the lower layer. In contrast to the first layer 13, which is in direct physical contact with the precursor sintered magnets 16, the second layer 19 is spaced at a distance from the precursor sintered magnets 16.

A second layer of precursor sintered magnets 16 is placed on the third layer 21 on the upper surface 22 of the second support 18. The paste including the dysprosium particles is not applied to the precursor sintered magnets 16, but to the second support 18 and the precursor sintered magnets 16 are placed in direct contact with the third layer 21. The container 15 also includes a lid 23 which is positioned above the upper layer precursor sintered magnets 16. The lower surface 24 of the lid 23 also includes a fourth layer 25 formed from the paste that includes dysprosium particles. The fourth layer 25 is spaced distance from the upper surface 22 of the precursor sintered magnets 16 of the upper layer of the stack.

In this particular embodiment, the layers 13, 19, 21, 25 further include a separation material in the form of neodymium oxide particles which are intimately mixed with the dysprosium hydride particles. After the diffusion heat treatment, the neodymium oxide particles remain solid particulate and enable the magnets to be removed from the residue of the first layer 13 and third layer 21.

The container is heated at a temperature in the range of 600° C. to 1100° C. for a time of between 0.1 hours and 100 hours such that the dysprosium from the layers 13, 19, 21, 25 is able to diffuse into the precursor sintered magnets 16, probably largely along the grain boundaries. The dysprosium may diffuse using a liquid phase mechanism and a gaseous phase mechanism. For example, the dysprosium particles in portions of the layer in direct contact with the precursor sintered magnet 16 can diffuse into the precursor sintered magnets using a liquid phase mechanism. Dysprosium from regions of the layer not in direct contact with the precursor magnet and spaced at a distance from the precursor sintered magnet 16 can diffuse by a gaseous phase mechanism to the outer surfaces of the precursors sintered magnet not in direct contact with the dysprosium particles and from this outer surface into the magnet along the grain boundaries. In one particular embodiment, the diffusion heat treatment takes place at 900° C. for 6 hours under a vacuum of 0.05 mbar.

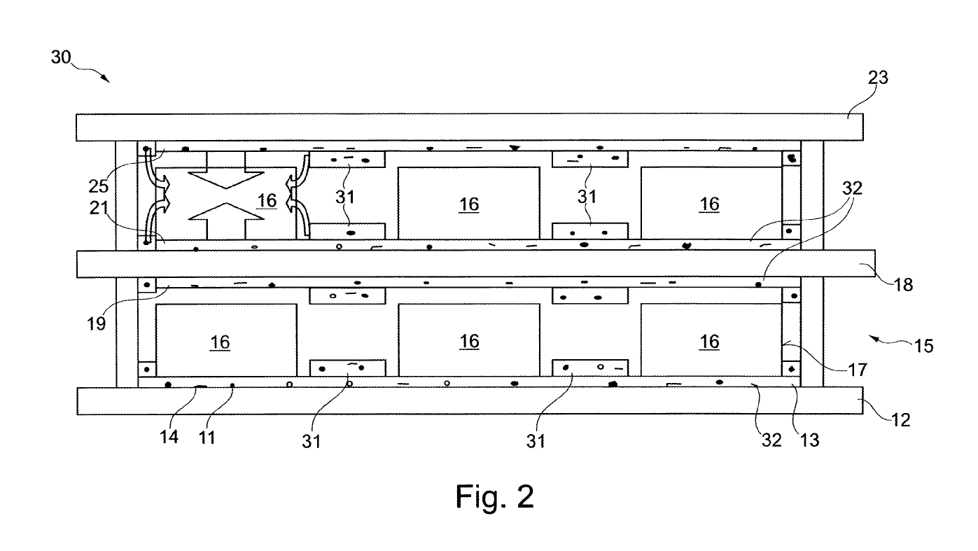

FIG. 2 illustrates an arrangement 30 for producing a rare earth-based magnet by treating the earth earth-based magnet using a diffusion process according to a second embodiment. Similar features are indicated with the same reference number. The arrangement 30 includes a container 15, first support 12, a second support 18 and lid 23 as in the first embodiment illustrated in FIG. 1. The arrangement 30 according to the second embodiment differs in the form of the layers 13, 19, 21, 25 including the dysprosium hydride and neodymium oxide particles. The layers 13, 19, 21, 25 have a variable thickness so that regions 31 of the layers 13, 19, 21, 25 positioned between precursor sintered magnets 16 have a greater thickness than regions 32 of the layers 13, 19, 21, 25 in direct contact with the precursor sintered magnets 16 or positioned directly above the precursor sintered magnets 16. This arrangement provides a larger source of dysprosium hydride in the thicker regions of the layers 13, 19, 21, 25. This larger amount of dysprosium hydride in the thicker regions can be used to further homogenise the distribution of Dy during the diffusion by a gaseous phase mechanism from the layer into the precursor sintered magnets.

After the diffusion heat treatment, the samples may be given a further annealing heat treatment under an argon atmosphere for 1 to 10 hours at a temperature of 350° C. to 850° C.

In some embodiments, the container may be dimensioned to contain only single magnet or a single layer of magnets or three or more stacked layers each including one or more magnets.

The combination of direct contact between one surface of the precursor sintered magnet and the dysprosium hydride source positioned within the layers and gaseous diffusion from the dysprosium hydride source spaced at a distance from the further surfaces of the precursor sintered magnets or just the use of gaseous diffusion from the dysprosium hydride source spaced at a distance from the precursor sintered magnets can be useful when treating precursor sintered magnets having an irregular form or form onto which it is more inconvenient or time-consuming to apply a layer.

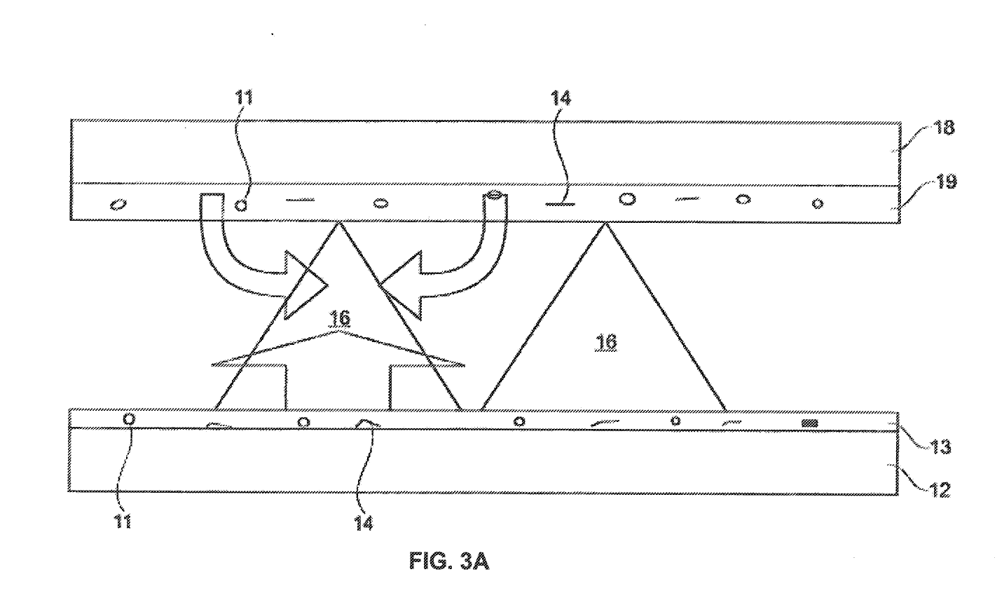

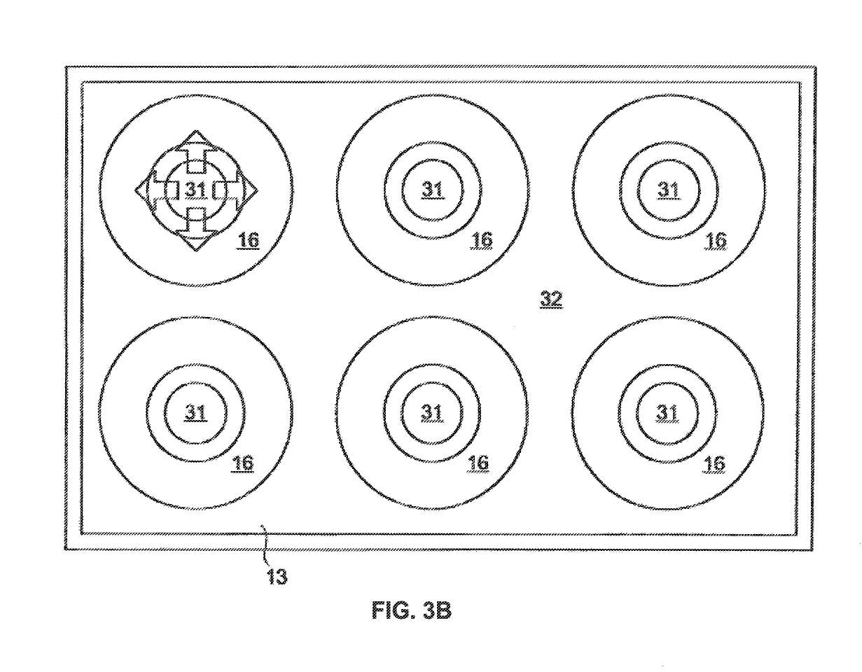

FIG. 3a illustrates an embodiment in which precursor sintered magnets having a prismatic form with a triangular cross-section are heat treated using an arrangement similar to that illustrated in FIG. 1. In the embodiment illustrated in FIG. 3, the second support lies directly on the precursor sintered magnets and the thickness of the layers 13, 19 is adjusted to achieve a homogeneous supply of Dy to all surfaces of the precursor sintered magnet 16. The precursor sintered magnets may also have the form of a ring. In the embodiment illustrated in FIG. 3b, the amount of the rare earth element R′ in the region 31 adjacent the centre of the ring may be greater than that in region 32 in order to provide a more homogeneous distribution of the rare earth element R′ after the diffusion treatment.

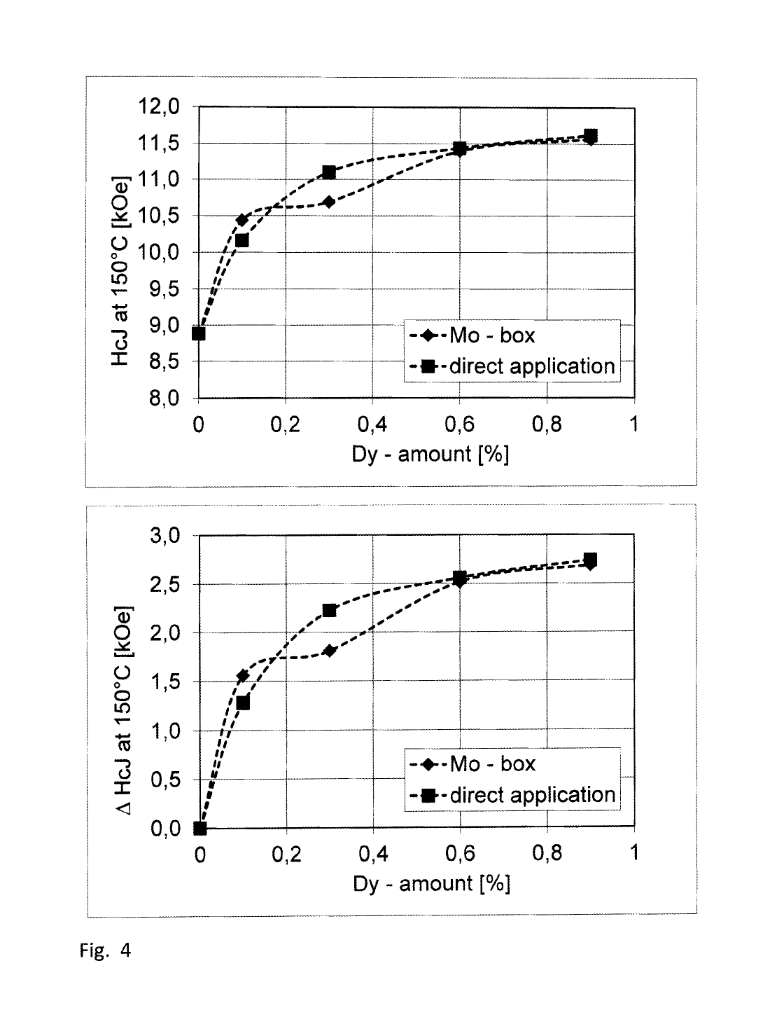

FIG. 4 illustrates a graph of coercivity and increase in coercivity for samples given a diffusion treatment for differing source amounts. A first set of comparison samples were fabricated in which the dysprosium hydride/neodymium oxide containing paste was applied directly to the precursor sintered magnets.

A second set of samples was prepared in which the dysprosium hydride/neodymium oxide containing paste was applied to the supports of a molybdenum box. FIG. 4 illustrates that a similar increase in coercivity is achieved for both sets of samples. Therefore, the particles of dysprosium hydride can be applied to the support rather than directly onto the precursor sintered magnets without this differing positioning of the particles of dysprosium hydride affecting the increase in coercivity observed after the diffusion treatment.

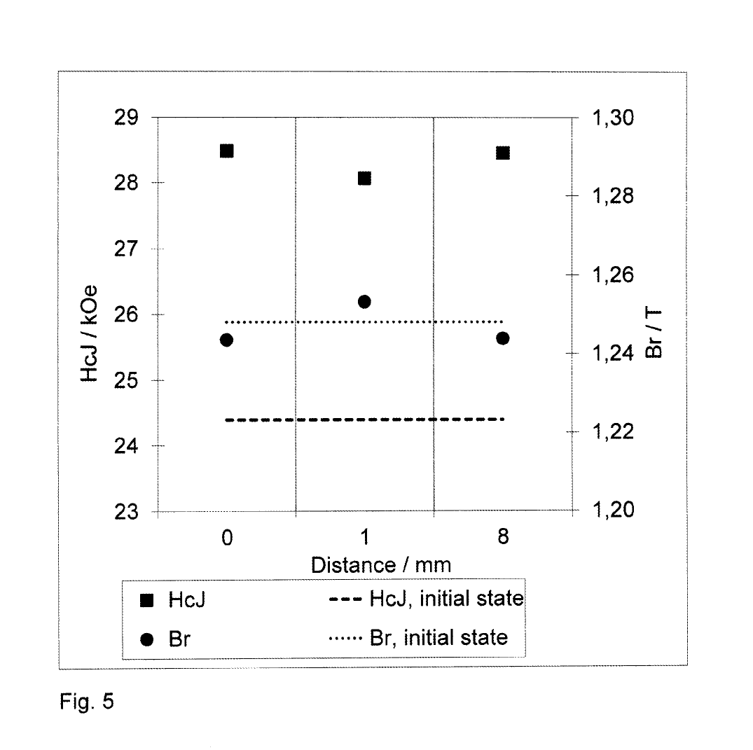

FIG. 5 illustrates a graph of coercivity and remanence for samples given a diffusion treatment with varying distances between the source and sample. The distance between the precursor sintered magnets and the source, i.e. the layer of dysprosium hydride and neodymium oxide particles, was adjusted to be 0 mm, 1 mm and 8 mm. A similar increasing coercivity was observed for all distances without a decrease in remanence compared to comparison sample which was not given a diffusion treatment. This is useful as the spacing between the dysprosium particles and the precursor sintered magnets does not have to be exactly defined but can vary within this range. The same container can be used for magnets of differing sizes for example.

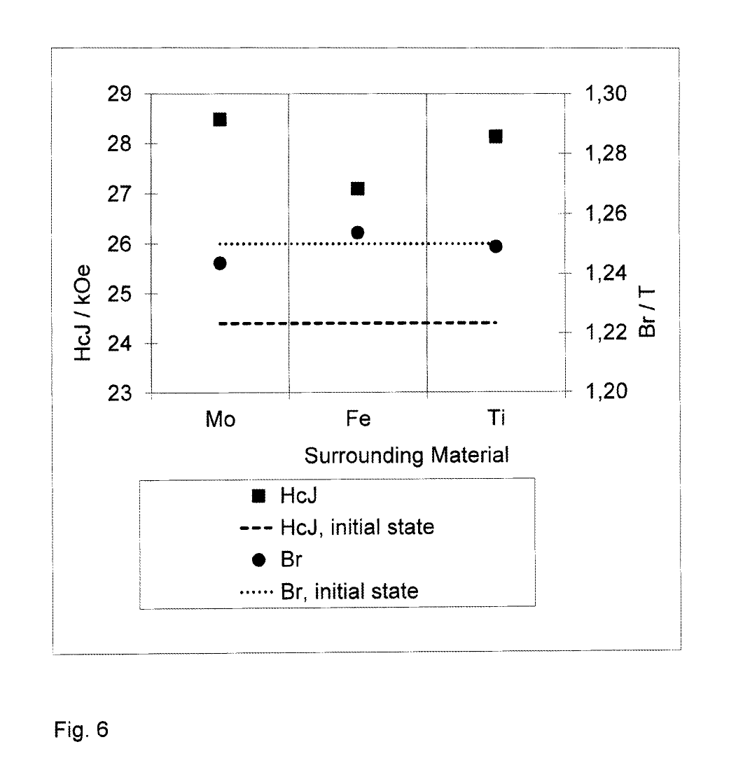

FIG. 6 illustrates a graph of coercivity and remanence for samples heat treated in containers of differing materials, in particular molybdenum, iron and titanium. The coercivity measured for each of the samples is increased over that of the comparison sample which did not undergo a diffusion treatment. However, the coercivity measured for the samples heat treated in the iron container is less than that measured for the samples heated using a molybdenum container and a titanium container. This may be the result of a reaction between the dysprosium hydride and iron which may lead to a decrease in the effective amount of the source of dysprosium.

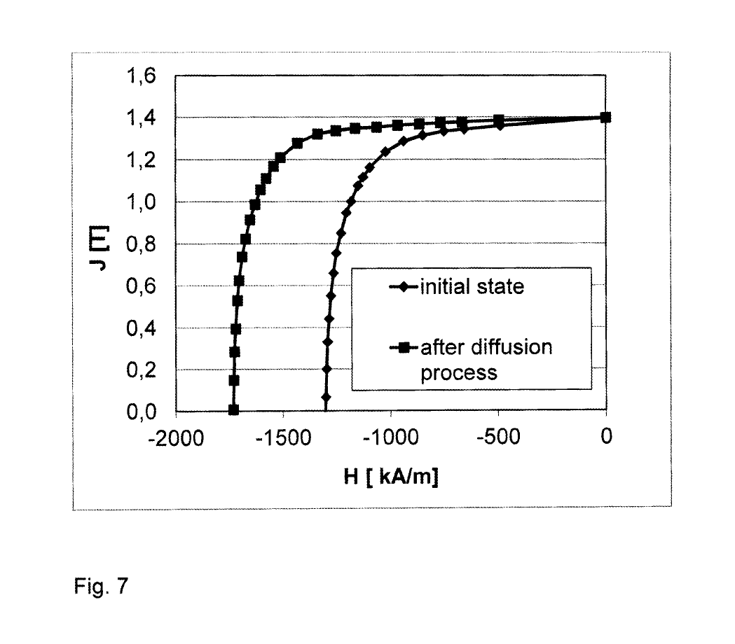

FIG. 7 is a graph illustrating an increase in coercivity for a sample having a prismatic form with a triangular cross-section. The samples were given a diffusion heat treatment at 900° C. for 6 hours using 0.6 weight percent dysprosium of which 0.25 weight percent of the sample was applied to the support and 0.35 weight percent was applied to the underside of the lid facing towards the point of the pyramid. FIG. 7 illustrates that an increase in coercivity of around 4 kOe at room temperature was achieved after the diffusion treatment. This illustrates that the method can be used to treat magnets having irregular shapes.

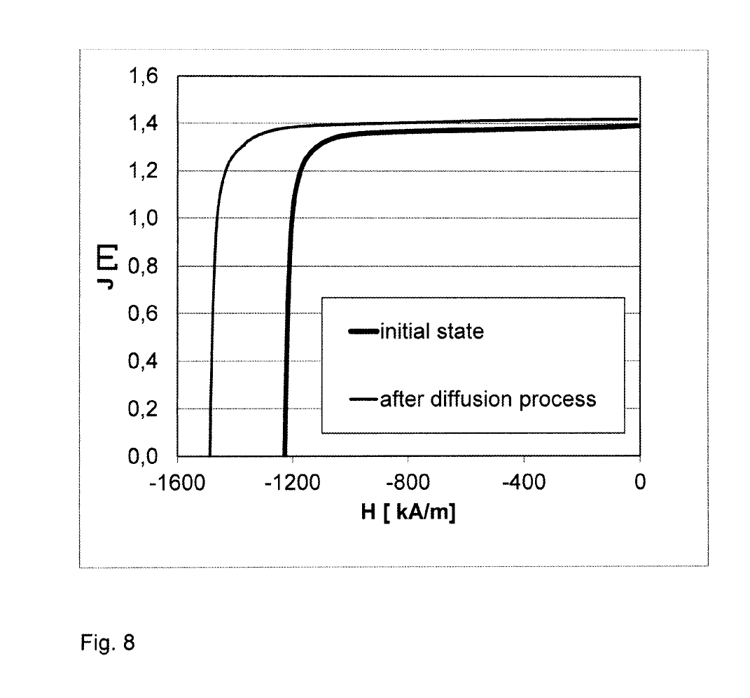

FIG. 8 is a graph illustrating the increase in coercivity for a sample having a quadratic form after a dysprosium diffusion treatment at 900° C. for 6 hours. A increase in coercivity of around 3.5 kOe was achieved.

TABLE 1

| Sample | a/mm | b/mm | c/mm | mass/g |
|---|---|---|---|---|
| 1 | 20.010 | 14.217 | 8.120 | 17.250 |
| 2 | 20.011 | 14.218 | 8.114 | 17.254 |
| 1′ | 20.019 | 14.224 | 8.136 | 17.278 |
| 2′ | 20.019 | 14.229 | 8.128 | 17.280 |

Table 1 illustrates the dimensions and mass of two quadratic samples before and after a dysprosium diffusion treatment. The samples show a slight increase in size of around 0.02 mm and an increase in mass of 0.025 g which is round 0.15% after the dysprosium diffusion treatment. The increase in mass is thought to be due to the uptake of dysprosium in the samples.

1. A method of treating a rare earth-based magnet, comprising:
providing at least one precursor sintered R₂Fe₁₄B-type magnet having a body;
providing a paste comprising particles comprising a rare earth element R′;
applying the paste to at least one surface other than a surface of the body and forming a layer of the particles on the at least one surface providing a source of the rare earth element R′;
placing the precursor sintered R₂Fe₁₄B-type magnet adjacent the layer;
diffusing the rare earth element R′ into the precursor sintered R₂Fe₁₄B-type magnet from the source, whilst the precursor sintered R₂Fe₁₄B-type magnet is adjacent the layer and increasing the content of the R′ rare earth element at least at the outer surface of the body, and
producing a rare earth-based magnet.

2. The method according to claim 1, wherein the precursor sintered R₂Fe₁₄B-type magnet is placed in direct contact with the layer and the rare earth element R′ is diffused into the precursor sintered R₂Fe₁₄B-type magnet, whilst the precursor sintered R₂Fe₁₄B-type magnet is in direct contact with the layer.

3. The method according to claim 1, wherein the precursor sintered R₂Fe₁₄B-type magnet is spaced at a distance from the layer and the rare earth element R′ is diffused into the precursor sintered R₂Fe₁₄B-type magnet, whilst the precursor sintered R₂Fe₁₄B-type magnet is spaced at a distance from the layer.

4. The method according to claim 1, further comprising applying particles of a separation material to the at least one surface.

5. The method according to claim 4, wherein the particles of the rare earth element R′ and the particles of the separation material are intimately mixed with one another and applied to the at least one surface in the form of a layer.

6. The method according to claim 4, wherein the particles of the rare earth element R′ and the particles of the separation material are mixed with at least one liquid or organic substance to form a paste and the paste is applied to the at least one surface.

7. The method according to claim 1, wherein one or more binders and/or one or more dispersants is added to the paste.

8. The method according to claim 1, wherein the paste is applied by painting or screen printing or doctor-blading or gravity or dipping or roller application or spraying.

9. The method according to claim 1, wherein the layer is dried before the precursor sintered R₂Fe₁₄B-type magnet is placed in direct contact with the layer.

10. The method according to claim 1, wherein the diffusing is carried out by heat treating the precursor sintered R₂Fe₁₄B-type magnet and the surface at a temperature T₁ and for a time t₁.

11. The method according to claim 10, wherein the temperature T₁ lies within the range of 600° C. to 1100° C. and the time t₁ lies within the range of 0.1 hours to 100 hours.

12. The method according to claim 10, wherein the heat treating is carried out under a pressure of less than 0.05 mbar.

13. The method according to claim 10, further comprising annealing the rare earth-based magnet in an inert atmosphere at a temperature T₂ for a time t₂ after the heat treating at the temperature T₁ for a time t₁.

14. The method according to claim 13, wherein the temperature T₂ lies within the range of 350° C. to 850° C. and the time t₂ lies within the range of 0.1 to 10 hours.

15. The method according to claim 10, wherein before being heat treated at the temperature T₁, the layer is dried.

16. The method according to claim 1, wherein the surface is part of a container and the precursor sintered R₂Fe₁₄B-type magnet is positioned in the container during the diffusing.

17. The method according to claim 1, wherein the surface is at least part of a support or a further object that is placed in a container and the precursor sintered R₂Fe₁₄B-type magnet is positioned in the container during the diffusing.

18. The method according to claim 1, further comprising applying the paste to at least one second surface, the at least one second surface being in direct contact with or spaced at a distance from the precursor sintered R₂Fe₁₄B-type magnet during the diffusing.

19. The method according to claim 1, wherein the layer has an area and a thickness, the thickness varying across the area.

20. The method according to claim 1, further comprising applying a first sublayer having a first thickness and applying a second sublayer having a second thickness on portions of the first sublayer.

21. The method according to claim 1, further comprising applying a first portion of the layer to a first surface and a second portion of the layer to a second surface, the first portion and the second portions having differing thicknesses.

22. The method according to claim 19, wherein at least one of the area and the thickness of the layer is configured such that a predetermined amount of the rare earth element R′ is provided.

23. The method according to claim 22, wherein at least one of the area and the thickness of the layer is configured such that a predetermined amount of the rare earth element R′ is provided depending on the amount of the R₂Fe₁₄B-type phase placed on the layer.

24. The method according to claim 19, wherein at least one of the area and the thickness of the layer configured such that a predetermined amount of the rare earth element R′ is provided in a predetermined portion of the magnet positioned adjacent the layer.

25. The method according to claim 19, wherein the precursor sintered R₂Fe₁₄B-type magnet is placed in direct contact with a thinner or thicker region of the layer.

26. The method according to claim 19, wherein a thicker or thinner region of the layer is arranged adjacent the precursor sintered R₂Fe₁₄B-type magnet.

27. The method according to claim 1, wherein the rare earth element R of the precursor sintered R₂Fe₁₄B-type magnet is different from the rare earth element R′.

28. The method according to claim 1, wherein the rare earth element R′ is Dy and/or Tb.

29. The method according to claim 1, wherein the rare earth element R′ is applied in the form of a hydride or a fluoride or a bromide or an iodide or an alloy or a hydrogenated alloy.

30. The method according to claim 1, wherein 0.01 wt % to 2 wt % or 0.1 wt % to 0.6 wt % of the rare earth element R′ in relation to the weight of the magnet is applied to the surface.

31. The method according to claim 4, wherein a volume ratio of the rare earth element R′ to the separation material is between 100 to 1 and 1 to 10.

32. The method according to claim 4, wherein the separation material is an oxide.

33. The method according to claim 32, wherein the separation material is an oxide of a rare earth element R″, where R″ is different from R and R′, or aluminium oxide or silicon dioxide.

34. The method according to claim 32, wherein the separation material is an oxide of one of the rare earth elements R, wherein R is different from R′.

35. The method according to claim 32, wherein the separation material is Nd₂O₃.

36. The method according to claim 4, wherein the paste comprises Nd₂O₃, fumed silica and 3-methoxy-1-butanol.

37. The method according to claim 1, wherein after the diffusing, the magnet comprises an increased content of the rare earth element R′

38. The method according to claim 1, wherein after the diffusing, the magnet comprises a rare earth element R′ having a distribution that varies from the outer surface in directions towards a centre of the magnet.

39. The method according to claim 1, wherein the rare earth element R′ content is highest at the outer surface and decreases in directions towards the centre of the magnet.
